(19) United States
(12) Patent Application Publication
(10) Pub. No.: US 2022/0162035 A1
(43) Pub. Date: May 26, 2022

(54) SLITTING DEVICE, SLITTING METHOD, AND LAMINATED TAPE

(71) Applicant: DEXERIALS CORPORATION, Shimotsuke-shi, Tochigi (JP)

(72) Inventors: Hiroki TAMANO, Utsunomiya-shi (JP); Katsuhiro DOI, Sendai-shi (JP); Kazuhiko NODA, Sendai-shi (JP); Tomohisa KAWAI, Kawachi-gun (JP)

(73) Assignee: DEXERIALS CORPORATION, Shimotsuke-shi, Tochigi (JP)

(21) Appl. No.: 17/599,094

(22) PCT Filed: Mar. 31, 2020
(86) PCT No.: PCT/JP2020/014951

§ 371 Date: Sep. 28, 2021

(30) Foreign Application Priority Data
Mar. 31, 2019 (JP) 2019-069545
Mar. 31, 2020 (JP) 2020-064948

(51) Int. Cl. B65H 35/02; B32B 7/12; B32B 43/00

(52) U.S. Cl. CPC B65H 35/02; B32B 7/12; B32B 2405/00; B65H 2404/10; B32B 43/003

(57) ABSTRACT

A laminated film, including an adhesive layer peelably laminated on a base film, and a carrier film overlapping each other are passed between a bladed roller including a plurality of disk-shaped slitting blades arranged at a pitch of 0.5 mm or less and an anvil roller with the laminated film on the bladed roller side to slit the laminated film by score cutting. The slitting blades have a blade angle of 30° or less. By doing so, the laminated film including the adhesive layer peelably laminated on the base film is silt to have a tape width of 0.5 mm or less in such a way that the base film and the adhesive layer do not peel apart and the protrusion of the adhesive layer is suppressed.

### TECHNICAL FIELD

The present invention relates to a slitting device and a slitting method for a laminated film including an adhesive layer peelably laminated on a base film, and a laminated tape obtained by slitting the laminated film.

### BACKGROUND ART

Long laminated tapes including an adhesive layer peelably laminated on a base film have been used as transfer ribbons for transferring patterns, letters, and the like to an article, etc. (Patent Literature 1). Such laminated tapes are manufactured by slitting a laminated film including an adhesive layer peelably laminated on a base film.

Long laminated tapes including an adhesive layer peelably laminated on a base film have also been used as adhesive members to package electronic parts on a substrate, and there has been a demand for narrow laminated tapes in recent years. However, slitting a laminated film including an adhesive layer peelably laminated on a base film to a narrow width causes a problem in that the base film and the adhesive layer peel apart due to the slitting. As a countermeasure against this problem, there is a large-scale method including covering the entire device that slits the laminated film by shear cutting using disk-shaped upper and lower blades with a hood to suppress temperature variations from when the laminated film is slit to when it is wound up (Patent Literature 2). According to this method, the laminated film can be slit to a tape width as small as 0.5 mm to 4 mm.

However, with the shear cutting using upper and lower blades, fine abrasion dust of the blades generated from the contact of the upper and lower blades can adhere to the slit tapes. In contrast, as a slitting method that produces no such abrasion dust and can relax the machining precision of the blades used to obtain clear cut sections, score cutting using a bladed roller and an anvil roller can involve slitting a film to be slit and a carrier film in conjunction (underlayer member) (Patent Literature 3).

### CITATION LIST

### Patent Literature

Patent Literature 1: Japanese Patent Application Laid-Open No. 2012-232392
Patent Literature 2: Japanese Patent Application Laid-Open No. 2007-90461
Patent Literature 3: Japanese Patent Application Laid-Open No. 2003-285293

### SUMMARY OF INVENTION

### Technical Problem

According to the method described in Patent Literature 2, the laminated film can be slit into tapes having a width as small as 0.5 mm. However, no detailed discussion has been made with regard to slitting into long tapes having a width as small as 0.5 mm or less. Moreover, the problem of the base and the adhesive layer peeling apart, discussed in Patent Literature 2, becomes more likely to occur as the film width decreases. There are therefore concerns about a drop in product yield and the like with narrow tapes having a width of 0.5 mm or less.

According to the description of Patent Literature 3, a polyester film can be slit to a width of 2 mm by using a bladed roller with a blade angle of 70°. However, if a laminated film including an adhesive layer peelably laminated on a base film is slit to produce a tape width of 0.5 mm or less by the method described in Patent Literature 3, the surface of the slit laminated film on the side where the blades cut into is highly compressed in the slit width direction due to the narrow blade pitch of the bladed roller compared to the other surface. This causes the problems of peeling and protrusion of the adhesive layer.

In light of this problem, an object of the present invention is to slit a laminated film, including an adhesive layer peelably laminated on a base film, to a tape width of 0.5 mm or less, or less than 0.5 mm in particular, with clear cut sections, without the base film and the adhesive layer peeling apart and without protrusion of the adhesive layer.

### Solution to Problem

The present inventors have conceived that if a carrier film is used with a slitting device for score cutting using a bladed roller and an anvil roller and the slitting blades of the bladed roller have a certain blade angle, a laminated film including an adhesive layer peelably laminated on a base film can be slit in such a way that the base film and the adhesive layer do not peel apart and also the protrusion of the adhesive layer from the slit tape can be suppressed, even with the slitting blades of the bladed roller at a pitch of 0.5 mm or less, or less than 0.5 mm in particular. With this conception, the present inventors have achieved the present invention.

More specifically, the present invention provides a slitting device including a bladed roller and an anvil roller and configured to slit a film by score cutting, the bladed roller including a plurality of disk-shaped slitting blades arranged at a predetermined pitch. Here, the slitting device includes a carrier film conveyance mechanism configured to interpose a carrier film between the film to be slit and the anvil roller. Furthermore, the slitting blades have a blade angle of 30° or less, and the pitch of the slitting blades is 0.5 mm or less.

The present invention also provides a slitting method for score cutting including slitting a laminated film including an adhesive layer peelably laminated on a base film by passing the laminated film and a carrier film overlapping each other between a bladed roller including a plurality of disk-shaped slitting blades arranged at a predetermined pitch and an anvil roller with the laminated film on the bladed roller side. Here, the slitting blades have a blade angle of 30° or less, and the pitch of the slitting blades is 0.5 mm or less.

The present invention further provides a laminated tape obtained by slitting a laminated film including an adhesive layer peelably laminated on a base film by the foregoing slitting method. The present invention also provides a laminated tape including an adhesive layer peelably laminated on a base film. Here, the laminated tape has a tape width of 0.5 mm or less, and the base film and the adhesive layer do not peel apart if a 1-m-long piece of the laminated tape is fixed at one end and a tensile force of 1 N is applied to the other end.

### Advantageous Effects of Invention

If a laminated film including an adhesive layer peelably laminated on a base film is slit by the slitting method of the present invention using the slitting device of the present invention, a laminated tape having a width of 0.5 mm or less, or a width of less than 0.5 mm in particular, can be obtained without the base film and the adhesive layer peeling apart. The base film and the adhesive layer do not peel apart even if a 1-m-long tape freely cut out of this laminated tape is fixed at one end and a tensile force of 0.5 N, preferably 1 N, and more preferably 5 N, is applied to the other end. Thus, when the laminated tape is wound up around a reel to form a roll, the tape can be pulled out of the roll for use without the base film and the adhesive layer peeling apart due to the tensile force during winding or pulling. Moreover, the adhesive layer does not protrude from the roll of the laminated tape, thus preventing the roll from blocking when unreeling. The laminated tape is therefore useful as a narrow pressure-sensitive adhesive member for attaching the adhesive layer to an article, and is also useful as an adhesive member if the adhesive layer is formed of a curable resin composition.

### BRIEF DESCRIPTION OF DRAWINGS

FIG. 1 is a schematic perspective view of a slitting device according to an embodiment.

FIG. 2 is a side view of the slitting device in slitting a laminated film, near a region where slitting blades (cutting blades) are arranged.

FIG. 3A is a cross-sectional view showing an assembly structure of a bladed roller and an anvil roller of the device according to the embodiment.

FIG. 3B is a cross-sectional view showing a modified aspect of the assembly structure of the bladed roller and the anvil roller.

FIG. 3C is a cross-sectional view showing a modified aspect of the assembly structure of the bladed roller and the anvil roller.

FIG. 4 is an enlarged cross-sectional view of a slitting blade portion in slitting the laminated film with the slitting blades of the device according to the embodiment.

FIG. 5 is an enlarged cross-sectional view of the slitting blade portion in slitting laminated films spliced to each other in a long-side direction by a joint tape.

FIG. 6 is an enlarged cross-sectional view of a slitting blade portion in slitting a laminated film with slitting blades having a blade angle of 70°.

### DESCRIPTION OF EMBODIMENTS

The present invention will be described in detail below with reference to the drawings. In the drawings, the same reference numerals denote the same or equivalent components.

### <Overall Configuration of Slitting Device>

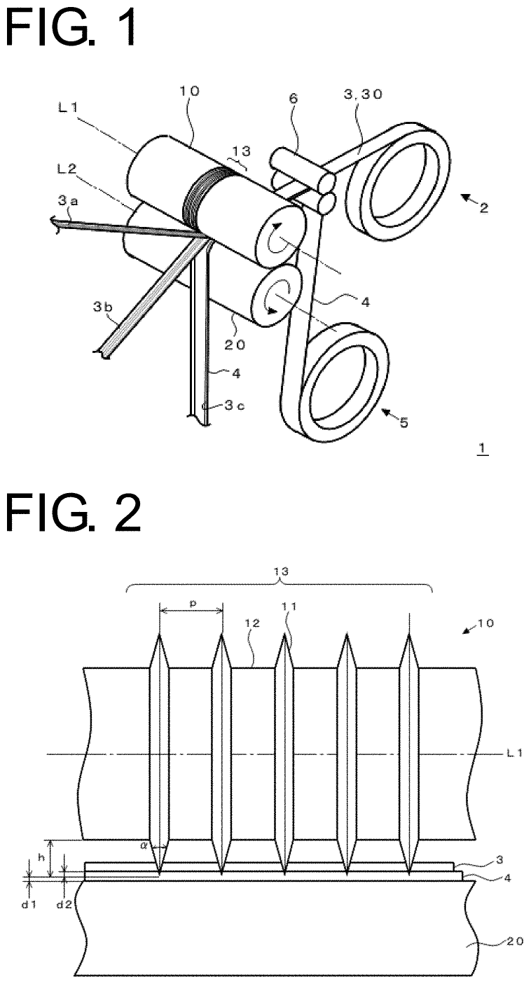

FIG. 1 is a schematic perspective view of a slitting device 1 according to an embodiment of the present invention. FIG. 2 is a side view of the slitting device 1 in slitting a film 3, near a region where slitting blades are arranged.

As shown in FIG. 2, the slitting device 1 is a device that slits the film 3 by score cutting and includes a cylindrical anvil roller 20 and a bladed roller 10 including a region 13 where disk-shaped slitting blades 11 are arranged on a cylindrical roller 12 at a predetermined pitch in the direction of a rotation axis L1 of the roller 12. Unlike shear cutting, where the upper and lower blades are in contact with each other, score cutting does not involve blade-to-blade contact and can increase blade life.

The slitting device 1 includes a film unwinding device 2 and winding devices (not shown) as a conveyance mechanism configured to pass the film 3 to be slit between the bladed roller 10 and the anvil roller 20. The winding devices may include both a winding device for winding up even-numbered rows of tapes 3a and a winding device for winding up odd-numbered rows of tapes 3b so that a plurality of adjoining rows of tapes obtained by slitting the film are wound up in respective different directions. In FIG. 1, the even-numbered rows of tapes 3a are shown to be wound up above, and the odd-numbered rows of tapes 3b are to be wound up below. However, the even-numbered rows of tapes may be wound up below, and the odd-numbered rows of tapes may be wound up above.

The slitting device 1 includes a carrier film unwinding device 5, a pair of laminate rollers 6 for laminating a carrier film 4 with the film 3, and a carrier film winding unit (not shown) for winding up side portions of the slit film (fringes of the film) and the carrier film 4 together, as a carrier film conveyance mechanism configured to interpose the carrier film 4 between the film 3 to be slit and the anvil roller 20.

As will be described below, the slitting device 1 can slit the film 3 to be slit to a width of 0.5 mm or less, or a width of less than 0.5 mm in particular, not only if the film 3 is a single-layer resin film or a laminated film formed by adhesively bonding or welding a plurality of resin layers, but also if the film 3 is a laminated film 30 (FIG. 4) including an adhesive layer 32 peelably laminated on a base film 31.

### <Slitting Blades>

The slitting blades 11 on the bladed roller 10 are preferably double-edged in view of stable slitting direction. Single-edged slitting blades (i.e., one of two blade surfaces forming a blade edge is flat and the other is a ridge surface) need wider margins in the width direction of the film to be slit and increase the amount of film edges wasted because the force acting on the slitting blades in the film width direction during slitting is higher on the flat surfaces than on the ridge surfaces, and the film is curved to the ridge side while being conveyed. In contrast, the force acting on double-edged slitting blades in the film width direction during slitting is equal on both sides. This can prevent the conveyance direction of the film from curving, and can reduce the amount of film edges wasted.

The slitting blades 11 have a blade angle α of 30° or less, preferably 25° or less in particular, so that the laminated film including the adhesive layer peelably disposed on the base film can be slit to a width as small as 0.5 mm or less, or less than 0.5 mm in particular, without the base film and the adhesive layer peeling apart. Meanwhile, the blade angle α is preferably 10° or more in view of durability of the slitting blades.

A pitch p of the slitting blades 11 is determined on the basis of the tape width needed for the tapes obtained by slitting the film 3. In the present invention, the upper limit is 0.5 mm or less, or less than 0.5 mm in particular, and can even be 0.4 mm or less, to accommodate narrow tapes. The lower limit is preferably 0.1 mm or more.

The slitting blades 11 preferably have a large blade height h in view of stable slitting precision. The lower limit is preferably 0.05 mm or more, more preferably 0.1 mm or more, and still further preferably 0.24 mm or more. Meanwhile, the slitting blades preferably have a small blade height h in view of the durability of the slitting blades. The upper limit is preferably 0.8 mm or less, more preferably 0.7 mm or less, and still further preferably 0.5 mm or less.

Suppose that a laminated film including an adhesive layer peelably laminated on a base film is slit with slitting blades having a blade angle α of 70° as described in Patent Literature 3, at a pitch of 0.5 mm or less. As shown in FIG. 6, the side of the laminated film 30 where the slitting blades 11 cut into undergoes a high compressive force F in the slit width direction compared to the opposite side, even if the laminated film 30 includes the adhesive layer 32 and a cover film 33 disposed on the base film 31 in order and the adhesive layer 32 is not exposed at the surface of the film. This can cause problems in that the base film 31 or the cover film 33 of the slit tape peels off the adhesive layer 32, or the adhesive layer 32 protrudes from tape sides to cause blocking when the tape is wound up into a roll. In contrast, the slitting blades 11 according to the present invention have a blade angle as small as 30° or less. This reduces the compressive force F acting on the side where the slitting blades 11 cut into as shown in FIG. 4 even with the slitting blades 11 at a pitch of 0.5 mm or less, or 0.1 mm or more and 0.4 mm or less in particular. The laminated film 30 including the adhesive layer 32 peelably laminated on the base film 31 can thus be slit without causing peeling therebetween, and the protrusion of the adhesive layer 32 from the tape sides can be prevented. Compared to wide tapes, narrow tapes are subjected to a relatively high force per tape cross-sectional area in the slit width direction, and are more likely to cause protrusion of the adhesive layer. The difficultly of preventing the protrusion of the adhesive layer 32 can thus be said to increase as the tape width decreases.

The bladed roller 10 including the region 13 where the slitting blades 11 are arranged with the foregoing blade angle α at the pitch p can use cut blades obtained by cutting a metal roller as shown in FIG. 2, combined blades formed by stacking circular blades having the blade angle α in the direction of the rotation axis, etc. Of these, the cut blades shown in FIG. 2 can be obtained by forming an easily cuttable alloy layer on the surface of a high-strength, high-durability roller 12 of carbon steel or the like, and cutting the easily cuttable alloy layer with a precision cutting machine using a diamond tool and the like. The combined blades can be obtained by forming individual slitting blades 11 by cutting, and combining the slitting blades at a predetermined pitch. The slitting blades have a blade angle of 30° or less and a pitch of 0.5 mm or less, preferably less than 0.5 mm, and more preferably 0.4 mm or less, and are not particularly limited in configuration as long as the effects of the present invention can be obtained.

A nickel-phosphorus alloy, a hard copper alloy, tool steel, cemented carbide, or the like can be used as the easily cuttable alloy (i.e., an alloy having high cuttability) forming the slitting blades. In view of durability, the easily cuttable alloy preferably has a Vickers hardness of 475 or higher, more preferably 500 or higher, still further preferably 550 or higher, and particularly preferably 1400 or higher.

### <Assembly of Bladed Roller and Anvil Roller>

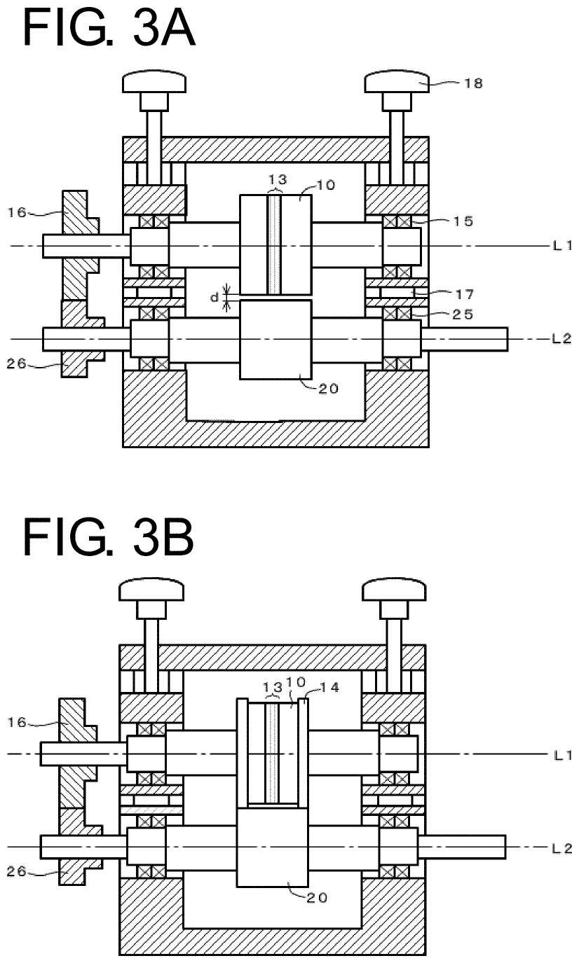

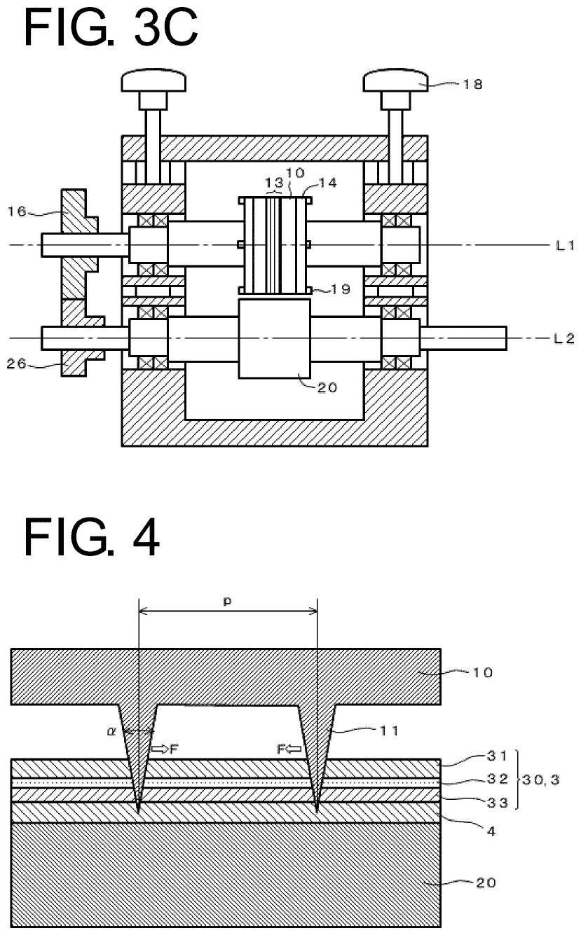

In the slitting device 1, as shown in FIG. 3A, the bladed roller 10 and the anvil roller 20 are supported by bearings 15 and 25, respectively, so that their rotation axes L1 and L2 are parallel to each other. The directions of the rotation axes L1 and L2 may be horizontal or vertical as long as the rotation axes L1 and L2 are parallel with each other. In view of stable running of the laminated film 30, the directions of the rotation axes L1 and L2 are preferably horizontal, with the bladed roller 10 located above the anvil roller 20. On the other hand, the directions of the rotation axes L1 and L2 are preferably vertical in view of less adhesion of foreign substances to the laminated film 30.

The bladed roller 10 and the anvil roller 20 are connected to each other by gears 16 and 26, and there is provided a driving mechanism configured to rotate these rollers in the directions of the arrows in FIG. 1. Alternatively, driving mechanisms configured to separately drive the bladed roller 10 and the anvil roller 20 to rotate may be provided.

The amount of cutting d2 of the slitting blades 11 into the carrier film 4 (FIG. 2) is, for example, preferably 10 to 100 μm, more preferably 10 to 50 μm, and still further preferably 10 to 20 μm, in view of continuous stable slitting. The slitting device 1 preferably includes an adjusting mechanism configured to move the attachment position of the bladed roller 10 with respect to the anvil roller 20 so that the amount of cutting d2 can be adjusted on the basis of the thickness of the carrier film 4. A linear guide mechanism and the like for moving the bladed roller 10 along guides 17 using adjustment screws 18 may be provided as the adjustment mechanism.

In the case of using a carrier film having a constant film thickness, large diameter portions 14 protruding more toward the anvil roller 20 than the blade edges of the slitting blades 11 may be provided on the bladed roller 10 as shown in FIG. 3B, and the large diameter portions 14 may be pressed against the anvil roller 20. The large diameter portions 14 can be pressed against the anvil roller 20 by a thrust force of around 800 N. Too large a thrust force causes a problem of warping the bladed roller 10. Alternatively, as shown in FIG. 3C, circular blades having a thickness of 0.5 mm or less, which are formed by cutting tool steel, cemented carbide, or the like into disks, followed by machining and finished by polishing, may be combined and fixed with bolts 19 to constitute combined blades so that the combined blades form the region 13 where the slitting blades are arranged. In the aspect shown in FIG. 3C, like the aspect shown in FIG. 3A, the attachment positions of the anvil roller 20 and the bladed roller 10 are adjusted with the adjustment screws 18. Thus, no thrust force for pressing the bladed roller 10 against the anvil roller 20 is needed.

### <Slitting Method>

A slitting method according to the present invention is a method for slitting the laminated film 30 including the adhesive layer 32 peelably laminated on the base film 31 by passing the laminated film 30 between the bladed roller 10 and the anvil roller 20 described above. The laminated film 30 and the carrier film 4 are passed while overlapping each other, with the laminated film 30 on the bladed roller 10 side and the carrier film 4 on the anvil roller 20 side, whereby the laminated film 30 is slit by score cutting (FIGS. 1 and 4). As will be described below, when the laminated film 30 includes the base film 31, the adhesive layer 32, and the cover film 33, the laminated film 30 is typically situated with the base film 31 on the bladed roller 10 side and the cover film 33 on the carrier film 4 side as shown in FIG. 4. In such a case, the cover film 33 and the carrier film 4 are adhesively bonded for slitting. After the slitting, the cover film 33 and the carrier film 4 are removed together from the adhesive layer 32. Conversely, the laminated film 30 may be slit with the cover film 33 on the bladed roller 10 side and the base film 31 on the carrier film 4 side.

While the carrier film 4 is half cut by the slitting, the laminated film 30 is cut through at a predetermined pitch. Of the plurality of rows of tapes obtained by cutting the laminated film 30 through, the even-numbered rows of tapes 3a and the odd-numbered rows of tapes 3b are wound up by the respective winding devices so that adjoining tapes are wound up in respective different directions.

The side portions 3c of the slit laminated film 30 (fringes of the laminated film) and the half-cut carrier film 4 are wound up together. The cover film 33 may also be wound up with the carrier film 4.

As described above, the amount of cutting d2 of the slitting blades 11 into the carrier film 4 is preferably 10 μm or more and 100 μm or less. The total thickness of the articles to be slit (the laminated film 30 and the carrier film 4) is preferably 90% or less with respect to the blade height h. For example, if the blade height is 300 μm, the total thickness of the articles to be slit is preferably 270 μm or less (FIG. 2). More preferably, the total thickness of the articles to be slit with respect to the blade height h is 70% or less, and still further preferably 50% or less.

The slitting is preferably performed in a clean room. A hood for covering the entire slitting device to suppress variations in environmental temperature is not needed but may be provided.

### <Laminated Film>

Examples of the laminated film 30 to be slit by the slitting method according to the present invention may include one obtained by peelably laminating a base film 31 having a thickness of 12 to 75 μm, or 25 to 75 μm in particular, an adhesive layer 32 having a thickness of 5 to 40 μm, or 5 to 25 μm in particular, and a cover film 33 thinner than that of the base film or having a thickness of 10 to 50 μm in order as shown in FIG. 4. As employed herein, being peelable refers to that the base film 31 or the cover film 33 can be easily peeled off the adhesive layer 32 by attaching an adhesive cellophane tape to the base film 31 or the cover film 33 and peeling the adhesive cellophane tape, or by pinching an end of the base film 31 or the cover film 33 with film pincers (hereinafter, pincers) and peeling the base film 31 or the cover film 33.

As shown in FIG. 4, during slitting, the base film 31 may be located on the side where the slitting blades 11 cut into, or the cover film 33 may be located on the side where the slitting blades 11 cut into.

Depending on the use of the laminated tapes obtained by slitting the laminated film, the laminated film 30 does not need to include the cover film 33. Stacking the carrier film 4 with the laminated film 30 increases the rigidity of the entire film. Even without the cover film 33, the adhesive layer 32 can thus be prevented from being peeled off the base film 31 because the adhesive layer 32 adheres to the slitting blades 11 immediately after the slitting. On the other hand, the presence of the cover film 33 is preferable in view of preventing contamination of the laminated tapes. The presence of the cover film 33 is particularly preferable in obtaining narrow laminated tapes. The rolls, the final form in which the laminated tapes are used as an adhesive member, may be either with the cover film for contamination prevention or without the cover film for improved workability.

### (Base Film, Cover Film)

The base film 31 may be a film formed of a thermoplastic resin such as polyethylene, polypropylene, or polyester like PET. The cover film 33 is provided to prevent contamination of the adhesive layer 32, and can be formed of the same material as that of the base film 31. The surfaces of the base film 31 and the cover film 33 are preferably subjected to a release treatment. The purpose is to enable separation from the adhesive layer. The cover film 33 is preferably more easily peelable than the base film 31 so that the cover film can be removed first after slitting.

In the present invention, the adhesive layer 32 having relatively low rigidity and the base film 31 having relatively high rigidity are simultaneously slit so as not to be separated during slitting. The adhesive layer 32 and the base film 31 can be peeled apart when the slit laminated tape is in use. Here, polyethylene, polypropylene, and polyester such as PET have a tensile modulus of approximately 1100 to 4200 MPa. Slitting a film formed of such a thermoplastic resin and the adhesive layer 32 having different rigidity than that of the film to a width as small as 0.5 mm or less at the same time and suppressing separation or peeling of the film and the adhesive layer during the slitting is a technique of high difficulty. The present invention enables such slitting.

### (Adhesive Layer)

The adhesive layer 32 may include a stack of adhesive films or a stack of pressure-sensitive adhesive coatings. Depending on the use of the tape obtained by slitting the laminated film 30, the adhesive layer 32 may include a single resin layer or a laminated or multilayered body of a plurality of resin layers. The adhesive layer 32 may contain a filler as needed.

### (Adhesive Layer Filler)

If the adhesive layer contains a filler, the filler is appropriately selected from conventional inorganic fillers (metals, metal oxides, metal nitrides, etc.), organic fillers (resins, rubbers, etc.), fillers made of a mixture of organic and inorganic materials, and the like, depending on the use of the tape obtained by slitting the laminated film 30. For example, for optical applications and delustering applications, a silica filler, a titanium oxide filler, a styrene filler, an acrylic filler, a melamine filler, various titanates, or the like can be used. For capacitor film applications, titanium oxide, magnesium titanate, zinc titanate, bismuth titanate, lanthanum oxide, calcium titanate, strontium titanate, barium titanate, barium titanate zirconate, lead titanate zirconate, mixtures thereof, or the like can be used. For adhesive applications, the adhesive layer can contain polymer rubber particles, silicone rubber particles, or the like. For electronic parts packaging applications, the filler may be electrically conductive or insulative. If the filler is insulative, the filler can be used as a spacer, for example.

The particle diameter of the filler can be determined on the basis of the use of the tape obtained by slitting the laminated film 30. For example, if the tape is used to package electronic parts, the filler preferably has a particle diameter of 1 μm or more, and more preferably 2.5 μm or more and 30 μm or less.

As employed herein, the particle diameter refers to an average particle diameter. The average particle diameter can be determined from a plan image or cross-sectional image of the adhesive layer 32 of the laminated film 30. The average particle diameter of the filler material particles before the filler is mixed into the adhesive layer 32 of the laminated film 30 can be determined using a wet flow particle diameter and shape analyzer FPIA-3000 (manufactured by Malvern Panalytical). N number, the number of samples, is 1000 or more, preferably 2000 or more, and more preferably 5000 or more. Fillers having a particle diameter of less than 1 μm may be included. Examples of fillers having a particle diameter of less than 1 μm (so-called nanofillers) may include viscosity control fillers. This size can be determined by observation under an electron microscope (TEM, SEM). N number is preferably 200 or more.

Fillers having a functionality, such as quantum dots, may be included. The size of such fillers is not limited in particular, and is preferably 2 nm or more, and preferably 10 nm or more. This size can also be determined by observation under an electron microscope (TEM, SEM). N number is preferably 200 or more.

In the present invention, the filler to be described below refers to one having the foregoing particle diameter of 1 μm or more unless otherwise specified. In other words, nanofillers used as a surface modifier or filler are excluded.

The filler may be mixed and randomly dispersed in the resin of the adhesive layer, disposed out of contact with each other in a plan view, or regularly arranged to repeat a predetermined pattern in a plan view. The number density of the filler is appropriately adjusted in a range in which the film slitting is not affected. For example, the number density is 30 to 100000 particles/mm² in a plan view. The number density is preferably measured by observing the filler in the adhesive layer in a plan view under an optical microscope or a metallographic microscope, at ten or more points with a total region of 2 mm² or more and with a total number of filler particles of 200 or more.

### (Resin Composition for Forming Adhesive Layer)

For the resin composition for forming the adhesive layer 32, one having tackiness or adhesiveness is appropriately selected on the basis of the use of the tape obtained by slitting the laminated film 30, the presence or absence of the filler, etc. The adhesive layer 32 can be formed of a thermoplastic resin composition, a high-viscosity tacky resin composition, a curable resin composition, or the like. For example, if the tape is used as an adhesive member for such uses as packaging electronic parts, the resin composition for forming the adhesive layer may be a curable resin composition containing a polymerizable compound and a polymerization initiator, like the resin composition for forming the insulating resin layer described in WO 2018/074318 A1. The resin composition may be a so-called hot melt type adhesive member containing no curable resin composition.

A thermal polymerization initiator may be used as the polymerization initiator for the curable resin composition. A photopolymerization initiator may be used. Both the initiators may be used in combination. For example, a thermal cationic polymerization initiator is used as the thermal polymerization initiator, an epoxy resin as the thermo-polymerizable compound, a photoradical polymerization initiator as the photopolymerization initiator, and an acrylate compound as the photopolymerizable compound. A thermal anionic polymerization initiator may be used as the thermal polymerization initiator. A microcapsule-type latent curing agent prepared by covering the surfaces of modified imidazole cores with polyurethane is preferably used as the thermal anionic polymerization initiator.

The minimum melt viscosity of the entire adhesive layer formed of such an insulating resin composition is not limited in particular, and can be 100 Pa·s or more in view of film formation. To suppress useless filler flow in bonding the adhesive layer 32 to an article by thermocompression, the minimum melt viscosity is preferably 1500 Pa·s or more. Meanwhile, the upper limit of the minimum melt viscosity is not limited in particular. For example, the upper limit is preferably 15000 Pa·s or less, and preferably 10000 Pa·s or less. The minimum melt viscosity can be determined, for example, by using a rotary rheometer (manufactured by TA Instruments) with a constant measurement pressure of 5 g and an 8-mm-diameter measurement plate. More specifically, the minimum melt viscosity can be determined in a temperature range of 30° C. to 200° C., at a temperature increase rate of 10° C./min, with a measurement frequency of 10 Hz and a load variation of 5 g with respect to the measurement plate. The minimum melt viscosity can be adjusted by changing the type and blending quantity of fine solid substances included as a melt viscosity modifier, and the preparation conditions of the resin composition.

### (Adhesive Force of Adhesive Layer)

Peelability

The adhesive force of the adhesive layer 32 to the base film 31 and the cover film 33 can be weaker than that of the adhesive layer 32 to a predetermined article that the adhesive layer 32 is attached to depending on the application of the tape, allowing the base film 31 and the cover film 33 to be peeled off the adhesive layer 32. Typically, the peelability of the base film 31 is evaluated after the cover film 33 is first peeled off and the adhesive layer 32 is subsequently attached to the article. As described above, the base film 31 and the cover film 33 are peelable off the adhesive layer 32. This peelability refers to how the base film 31 and the cover film 33 can be easily peeled off the adhesive layer 32 by attaching an adhesive cellophane tape to the base film 31 or the cover film 33 and peeling the adhesive cellophane tape, or by pinching an end of the base film 31 or the cover film 33 with pincers and peeling the base film 31 or the cover film 33. A specific range of peelability is an adhesive strength of 0.005 to 0.2 N when the unslit laminated film is cut into a 5-cm-wide 15-cm-long piece and a T-peel test (JIS K 6854) is performed thereon as a peel test. A 180° peel test or 90° peel test may be used for evaluation, depending on the material, thickness, and other properties of the base film 31. The cover film 33 is typically peeled off the base film 31 and the adhesive layer 32 first by using an adhesive cellophane tape. Next, the adhesive layer 32 is attached to the article, and then the base film 31 is peeled off with pincers.

Stability

When the laminated film 30 is slit into a tape and the tape is wound up on a reel by a winding device to form a roll, or when the roll is loaded onto a connection device and the tape is pulled out of the roll to be used as an adhesive member, the tape is subjected to tension (tensile force) in the long-side direction of the tape. The base film 31 and the adhesive layer 32 are thus preferably prevented from peeling when such tension acts on the tape. Specifically, a tape length conventionally desired of the roll on the connection device is typically 5 m or more, and preferably 10 m or more. The tension acting on the tape being pulled out of the roll in the long-side direction is typically around 1 N to 5 N. Moreover, the reel can be locked and a tension of 5 to 6 N can act on the tape if a malfunction occurs while the connection device is in operation. That a load of around 5 N can act on the tape therefore needs to be taken into account. Thus, the bonding state between the base film and the adhesive layer, as well as the connection of the reel and the base film (connection of a lead extended from the reel and the base film with an adhesive film such as a silicone tape or by ultrasonic welding) are preferably maintained even under such tension.

However, if the conventional tension is applied to a narrow tape, the base film can sometimes be broken or the base film and the adhesive layer can peel apart. In winding up or pulling out the narrow tape using available equipment as much as possible, the tension acting on the tape in the long-side direction can therefore be set to around 0.5 N, and preferably less than 1 N. The upper limit is more preferably 0.7 N or less, and still more preferably 0.3 N or less.

From such practical requirements in enabling winding-up and pulling-out, the adhesive layer 32 needs to have stability so that the base film 31 and the cover film 33 do not peel off the adhesive layer 32 when a 1-m-long or longer piece, preferably a 5-m-long or longer piece, of the laminated tape slit to a width of 0.1 mm or more and 0.5 mm or less by the method of the present invention is subjected to a tensile force of 0.5 N or more, preferably 1 N, more preferably 5 N, in the long-side direction. While the foregoing peelability is a property related to the upper limit of the adhesive force of the adhesive layer 32 to the base film 31 and the cover film 33, this stability is a property related to the lower limit of the adhesive force.

Stability tests are preferably performed in a simplified manner. In one test method, the test length of the laminated tape is 1 m. A laminated tape cut into the test length of 1 m is fixed at one end, while a load of 0.5 N, preferably 1 N, more preferably 5 N, is applied to the other end, and the presence or absence of peeling between the base film 31 and the adhesive layer 32 is observed. In a more practical test method, the tape is pulled out of the roll by 1 m or more, and the presence or absence of peeling is observed with a load of 0.3 N, 0.5 N, 1 N, or 5 N applied to the end of the tape. Alternatively, the entire length of tape may be pulled out of the roll, and the presence or absence of peeling may be observed at 20 points or more, preferably 50 points or more, at random. Examples of the range of the adhesive force needed for practical use in such a test may include the following: (i) The base film does not peel off the adhesive layer if the laminated film is slit into a laminated tape having a width of 0.1 mm or more and 0.5 mm or less by the method of the present invention, the tape including the adhesive layer and the base film is wound into a tape roll with the cover film removed, one meter of tape is pulled out of the roll and the joint position between the winding core of a reel and the tape is fixed, and a tension of 0.3 N, preferably 0.5 N, preferably 1 N, more preferably 5 N, is applied as a static load to the tape end with a joint position angle of a (Japanese Patent Application Laid-Open No. 2017-137188) of 90°, and no protrusion occurs affecting the pulling-out; (ii) the base film 31 does not peel off the adhesive layer 32 if a specimen having a test length of 1 m is freely cut out of the laminated tape into which the laminated film is slit to a width of 0.1 mm or more and 0.5 mm or less by the method of the present invention, and a tensile force of 0.5 N, preferably 1 N, more preferably 5 N, is applied to the specimen in the long-side direction; and (iii) no peeling of the adhesive layer and the base film is visually confirmed over the entire length of the tape (details will be described in an embodiment to be described below) when the entire tape including the adhesive layer and the base film is manually pulled out of a roll, which consists of 5 m or more tape wound around a winding core with 0.5 N. In view of simplified testing, the method (iii) is preferable. The absence of peeling between the base film and the adhesive layer may be confirmed by cutting the tape into a test length of around 1 m and manually applying a load (approximately 1 N to 5 N) to both ends.

Suppose that the laminated tape having the foregoing adhesive force is wound into a roll of preferably 5 m or more, 10 m or more, 50 m or more, or 100 m or more in length, and the tape is pulled out of the roll preferably by 1 m or more, and more preferably 5 m or more. Even in such a case, the peeling of the base film 31 of the pulled-out tape off of the adhesive layer 32 can be prevented. Such a tape can be put to practical use in packaging electronic parts.

Adhesive Force to Object to be Connected

As a method for testing the required adhesive force of the adhesive layer to an object to be connected such as an electronic part and a substrate, a peel test may be performed in which a freely sampled 2-cm-long small piece of the laminated tape (small piece cut out of the 1-m specimen of the laminated tape according to the foregoing method (ii) may be used) is temporarily bonded to a blank glass (for example, bonded at 45° C.) with the adhesive layer in contact with the blank glass, and only an end of the base film 31 (or cover film 33) is pinched with pincers to remove the base film 31 (or cover film 33). The peel test is determined to be successful if only the base film 31 (or cover film 33) can be removed and the adhesive layer remains bonded to the blank glass without a change in shape. This peel test preferably succeeds at a rate of 75% or more, more preferably 80% or more, still further preferably 90% or more, with N, the number of samples, at 20 or more.

### (Bonding of Joint Tape)

A joint tape may be bonded to the laminated film 30 to attach a lead to the laminated film 30 at the beginning of winding or unwinding of a roll, or to bond a first laminated film and a second laminated film together for extension. The joint tape and the laminated film 30 can be joined at a plurality of locations regularly or at random. The lead can be attached to the laminated film by joining the base film 31 of the laminated film 30 and the lead together with a joint tape. The lead may be attached to the laminated film by a conventional method such as ultrasonic welding.

A highly peelable adhesive tape with a base material, having a relatively small total thickness (such as a silicone tape) can be used as the joint tape. The thickness of the joint tape is not limited in particular, and may be 5 to 75 μm, for example.

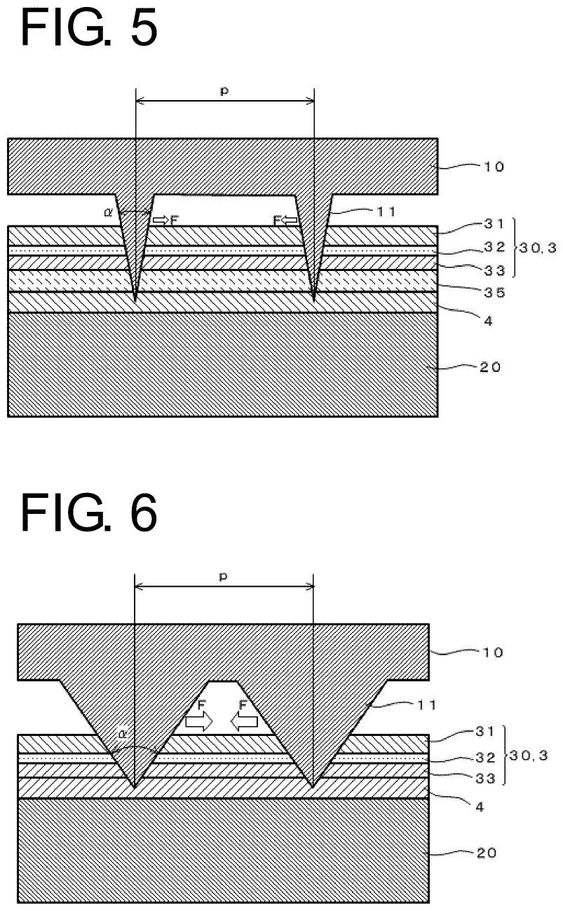

In slitting the portion of the laminated film 30 where the joint tape is bonded, the slitting blades 11 cut deeply into the stack of the laminated film 30 and a joint tape 35 as shown in FIG. 5. With a conventional slitting device, the surface of the stack where the slitting blades 11 cut into therefore undergoes a high compressive force F from the side surfaces of the slitting blades 11 due to extremely small distances between adjoining blades, compared to the opposite surface. The cover film 33 or the base film 31 is thus likely to peel off the adhesive layer 32, or the adhesive layer 32 is likely to protrude from the side surfaces of the slit stack. In contrast, according to the present invention, the occurrence of such peeling or protrusion can be suppressed despite the bonding of the joint tape 35 to the laminated film 30.

### <Laminated Tape>

The laminated tape according to the present invention is a tape obtained by slitting the laminated film 30 by the foregoing slitting method. Therefore, this tape is a laminated tape including the adhesive layer peelably laminated on the base film. The upper limit of the tape width is 0.5 mm or less, and less than 0.5 mm in particular, and is more preferably 0.4 mm or less, and still further preferably 0.3 mm or less. The lower limit is 0.1 mm or more, preferably 0.15 mm or more, and more preferably 0.2 mm or more.

The laminated tape is characterized in that the base film does not peel off the adhesive layer if a specimen freely cut out of the tape to a test length of 1 m is fixed at one end and a tensile force of 0.3 N, 0.5 N, or 1 N is applied to the other end, and that the adhesive layer 32 does not protrude from the roll. The laminated tape also satisfies practical requirements that the adhesive layer be less peelable off a blank glass if the tape is cut into a 2-cm-long small piece, the adhesive layer 32 is bonded to the blank glass, and only an end of the base film 31 is pinched with pincers and the base film 31 is removed. The laminated tape thus enables so-called bonding and transfer.

In view of handleability, the tape is preferably formed into a roll wound around a reel. In view of practical use, the roll preferably has a tape length of 5 m or more and 5000 m or less, more preferably 50 m or more and 1000 m or less, and still further preferably 500 m or less. Typically, the smaller the tape width, the more likely the roll is to cause blocking. According to the laminated tape of the present invention, the roll is less likely to cause blocking, and no peeling occurs between the base film 31 or cover film 33 and the adhesive layer 32 of the tape even if the tape is pulled out of the roll by 5 m or more.

In general, a laminated tape obtained by slitting a laminated film can cause a visual lift (discolored portion) at the edges that are the slit sections. With a tape width as small as 0.5 mm or less, lifts at both edges of the laminated tape can cause useless peeling of the base film and the adhesive layer. However, according to the present invention, the laminated film is slit with sharp double-edged blades, and lifts are less likely to be observed if the entire length of tape forming a roll is visually observed for a lift at freely-selected 20 points or more, preferably 50 points or more. A lift, if there is any lift observed on an edge along a slit section of the laminated tape, has only a length of less than 5 cm and a width of 40% or less, ⅓ or less in particular, of the tape width, whereby peeling of the base film and the adhesive layer can be suppressed.

As described above, according to the laminated tape of the present invention, the base film and the adhesive layer are less likely to deviate from each other, and blocking and a lift are less likely to occur. This improves the workability in winding a roll and pulling the tape out of the roll, and the cut piece of the tape pulled out of the roll can be attached to a target member without much deviation in the attached position. The laminated tape according to the present invention can thus be used for various applications as a narrow pressure-sensitive adhesive member or an adhesive member. In such a case, the type and the like of the resin composition constituting the adhesive layer 32 are selected as appropriate on the basis of the target member for the tape to be bonded to.

### EMBODIMENTS

### Embodiment 1

A laminated film including a base film formed of a 38-μm-thick release-treated PET film, an adhesive layer formed of a 10-μm-thick acrylic thermosetting resin (adhesive film, manufactured by Dexerials Corporation), and a cover film formed of a 12-μm-thick PET film was slit into 0.3-mm-wide 100-m-long tapes by a single operation using the cutting blades shown in FIG. 2. With the cover film removed, the base film and the adhesive layer were wound up around ϕ-90-mm flanged winding cores (flange-to-flange distance of 0.4 mm) with a tensile force (winding tension) of 0.3 to 0.6 N to form rolls, which were subjected to the following evaluations.

### (1) Lift

The entire 100-m tape was manually pulled out of a roll, and 10-cm-long test regions of the pulled-out tape were visually observed at optional 20 points and evaluated with reference to the following criteria on the basis of the following items a, b, and c related to the presence or absence of a lift.

a: no lift of 5 cm or more in length

b: no lift with a width greater than ⅓ of the tape width

c: no more than five lifts of less than 5 cm in length or with a width ⅓ or less of the tape width

Rank A: all items a, b, and c were satisfied

Rank B: both the items a and b were satisfied

Rank C: other than the foregoing ranks A and B

The evaluation result was rank A. There is no practical problem if rank B is satisfied. c is preferably satisfied as well.

### (2) Peeling

The absence of peeling was confirmed at a total of 50 points, including the points where a lift was visually observed in the foregoing test and 30 other points. During the test, almost no peeling was found by visual observation over the entire length pulled out.

There occurred no protrusion of the adhesive layer that interfered with workability. No adhesion of the adhesive layer to the flanges was confirmed, either.

Note that the foregoing results (1) and (2) are not limited to slitting with the cutting blades.

### REFERENCE SIGNS LIST

1 slitting device
2 film unwinding device
3 film
4 carrier film
5 carrier film unwinding device
6 laminate roller
10 bladed roller
11 slitting blade, circular blade
12 roller
13 region
14 large diameter portion
15 bearing
16 gear
17 guide
18 adjustment screw
19 bolt
20 anvil roller
25 bearing
26 gear
30 laminated film
31 base film
32 adhesive layer
33 cover film
35 joint tape
α blade angle of slitting blade
d1 gap between blade edge of the slitting blade and anvil roller
d2 amount of cutting of slitting blade into carrier film
F compressive force
h blade height of slitting blade
L1, L2 rotation axis
p pitch of slitting blade

1. A slitting device including a bladed roller and an anvil roller, the slitting device being configured to slit a film by score cutting, the bladed roller including a plurality of disk-shaped slitting blades arranged at a predetermined pitch,
the slitting device comprising a carrier film conveyance mechanism configured to interpose a carrier film between the film to be slit and the anvil roller, wherein
the slitting blades have a blade angle of 30° or less, and
the pitch of the slitting blades is 0.5 mm or less.

2. The slitting device according to claim 1, wherein the blade angle of the slitting blades is 10° or more.

3. The slitting device according to claim 1, wherein the pitch of the slitting blades is 0.1 mm or more and 0.4 mm or less.

4. The slitting device according to claim 1, wherein the slitting blades have a blade height of 0.05 mm or more and 0.8 mm or less.

5. The slitting device according to claim 1, comprising an adjusting mechanism configured to move an attachment position of the bladed roller with respect to the anvil roller.

6. A slitting method for score cutting comprising slitting a laminated film including an adhesive layer peelably laminated on a base film by passing the laminated film and a carrier film overlapping each other between a bladed roller including a plurality of disk-shaped slitting blades arranged at a predetermined pitch and an anvil roller with the laminated film on the bladed roller side, wherein
the slitting blades have a blade angle of 30° or less, and
the pitch of the slitting blades is 0.5 mm or less.

7. The slitting method according to claim 6, wherein the blade angle of the slitting blades is 10° or more.

8. The slitting method according to claim 6, wherein the pitch of the slitting blades is 0.1 mm or more and 0.4 mm or less.

9. The slitting method according to claim 6, wherein the laminated film is obtained by peelably laminating a cover film on the adhesive layer.

10. The slitting method according to claim 6, wherein a joint tape is bonded to the laminated film.

11. A laminated tape obtained by slitting a laminated film including an adhesive layer peelably laminated on a base film by the slitting method according to claim 6.

12. A laminated tape comprising an adhesive layer peelably laminated on a base film, wherein the laminated tape has a tape width of 0.5 mm or less, and the base film and the adhesive layer do not peel apart if a 1-m-long laminated tape freely cut out of the laminated tape is fixed at one end and a tensile force of 1 N is applied to the other end.

13. The laminated tape according to claim 12, wherein the tape width thereof is 0.1 mm or more and 0.4 mm or less.

14. The laminated tape according to claim 12, wherein a cover film is peelably laminated on the adhesive layer.

15. The laminated tape according to claim 12, wherein a joint tape is bonded.
